(19) United States
(12) Patent Application Publication
(10) Pub. No.: US 2013/0052979 A1
(43) Pub. Date: Feb. 28, 2013

(54) Initiative notification apparatus and the notifying method thereof

(71) Applicants: Ching-Paio CHIANG, Hsinchu City (TW); Tsung-Min YEH, Zhubei City (TW)

(72) Inventors: Ching-Paio CHIANG, Hsinchu City (TW); Tsung-Min YEH, Zhubei City (TW)

(21) Appl. No.: 13/420,128

(22) Filed: Mar. 14, 2012

(30) Foreign Application Priority Data
Aug. 23, 2011 (TW) 100130185

(51) Int. Cl. H04W 4/22; H04W 12/06

(52) U.S. Cl. 455/404.1

(57) ABSTRACT

An Initiative notification apparatus comprises an input module, an identification module connected to the input module, and a notifying module connected to the identification module, wherein the Initiative notification apparatus is characterized in that: the notifying module performs a notifying process according to a control signal output by the identification module, and at least one recipient end is notified in the notifying process and each recipient end is notified at least once to enhance the notifying function of the Initiative notification apparatus.

The current application claims a foreign priority to a patent application in Taiwan with a serial number 100130185 filed on 8-23-2011.

### BACKGROUND OF THE INVENTION

1. Field of the Invention

The present invention is related to an Initiative notification apparatus and the notifying method thereof, and more particularly, to an Initiative notification apparatus and its notifying method in which a setup signal is output to at least one recipient end when the password entered is identified as an emergency code to initiate emergency response procedures; the primary objective of which is to effectively reinforce defects of conventional notifying systems with regard to safety maintenance and thus achieve effects of protecting personal safety and property and safeguarding public order.

2. Description of the Prior Art

During recent years, criminal events such as kidnapping, burglary, and theft have frequently occurred and almost become unpreventable. At the same time, the contemporary society has also placed greater emphasis on personal safety, residential security, and property protection. A large number of security apparatuses are thus developed to meet such demands.

As far as the design of security apparatuses currently available is concerned, when the user is at risk, a setup button or apparatus needs to be hit or activated for sending an emergency message. However, the intention of victims to perform this necessary act of activation or the act itself is often noticed by culprits, who may be provoked to hurt victims for self-protection.

To compensate for the deficiency of the aforementioned security apparatuses in terms of protection of personal or property safety, the present invention mainly provides an Initiative notification apparatus and the notifying method thereof, with which the password entered by the user is identified by the apparatus to determine whether there is an emergency at present and automatically outputs a setup signal to at least one recipient end to activate emergency response procedures; therefore, the Initiative notification apparatus provided by the present invention is able to automatically operate and perform a notifying process while culprits are still unaware and thus ensure personal and property safety of the user.

### SUMMARY OF THE INVENTION

In order to solve the problem mentioned above, one objective of the present invention is to provide an Initiative notification apparatus that comprises an input module, an identification module, an activation module, and a notifying module, with which a setup signal is output by the notifying module to at least one recipient end when the password entered is identified as an emergency code to activate emergency response procedures and protection of personal and property safety is thereby enhanced.

Another objective of the present invention is to provide an Initiative notifying method, in which a setup signal is output by the notifying module to at least one recipient end when the password entered is identified as an emergency code to activate emergency response procedures and assistance request mechanism is thereby reinforced to effectively enhance protection of personal and property safety.

Still another objective of the present invention is to provide a notifying process, according to which the notifying module outputs a setup signal to at least one recipient end and further informs several different parties simultaneously when the password entered is identified as an emergency code, wherein one same party is informed more than once and protection of personal and property safety is thus more effectively enhanced.

According to the objectives described above, the present invention first provides an Initiative notification apparatus, which comprises an input module, an identification module connected to the input module, and a notifying module connected to the identification module, wherein the Initiative notification apparatus is characterized in that: the notifying module performs a notifying process according to a control signal output by the identification module, and at least one recipient end is notified by the notifying process and each recipient end is notified at least once.

The present invention then provides an Initiative notification apparatus, which comprises: an input module for the user to enter a password; an identification module connected to the input module and provided with a notifying process, wherein at least a password for security mode and a password for emergency mode are set up in the notifying process for the notifying process to match the password entered with the password for security mode and the password for emergency mode for identification and outputs at least a first control signal and/or a second control signal after the identification is completed; a notifying module connected to the identification module and provided with a notifying process, which performs the notifying process according to the second control signal output by the identification module; wherein, when the identification module identifies the password entered as the same as the password for security mode, the identification module outputs a first control signal, and when the identification module identifies that the password entered is the same as the password for emergency mode, the identification module outputs a first control signal and a second control signal to perform a notifying process.

The present invention further provides an Initiative notifying method, which is provided in an Initiative notification apparatus comprising an input module, an identification module connected to the input module, and a notifying module connected to the identification module; the Initiative notifying method comprises: entering a password, wherein the user enters a password via the input module; identifying the password, wherein at least a password for security mode and a password for emergency mode are set up in the identification module, and a notifying process matches the password entered with the password for security mode and the password for emergency mode for identification and outputs at least a first control signal or a first control signal and a second control signal after the identification is completed; outputting a first control signal when the identification module identifies the password entered as the same as the password for security mode; outputting a first control signal and simultaneously a second control signal when the identification module identifies the password entered as the same as the password for emergency mode, and the notifying module performing a notifying process after receiving the second control signal.

The present invention further provides a notifying process provided in an Initiative notification apparatus comprising an input module, an identification module connected to the input module, and a notifying module connected to the identification module; the notifying process comprises: entering a password, wherein the user enters a password via the input module; identifying the password entered, wherein at least a password for security mode and a password for emergency mode are set up in the identification module, and a notifying process matches the password entered with the password for security mode and the password for emergency mode for identification and outputs at least a first control signal or a first control signal and a second control signal after the identification is completed; outputting a first control signal when the identification module identifies the password entered as the same as the password for security mode; outputting a first control signal and a second control signal when the identification module identifies the password entered as the same as the password for emergency mode, and the notifying module performing a notifying process after receiving the second control signal.

With the Initiative notification apparatus, notifying method, and notifying process provided by the present invention, personal and property safety can be effectively protected and social order overall can be further enhanced and maintained.

### BRIEF DESCRIPTION OF THE DRAWINGS

FIG. 1 is a function block diagram of the Initiative notification apparatus of the present invention;

FIG. 2 is a diagram of an embodiment of the notifying process of the Initiative notification apparatus of the present invention;

FIG. 3 is a diagram of another embodiment of the notifying process of the Initiative notification apparatus of the present invention; and

FIG. 4 is a diagram of the notifying process of the notifying process of the Initiative notification apparatus of the present invention.

### DETAILED DESCRIPTION OF THE PREFERRED EMBODIMENT

The present invention mainly discloses an Initiative notification apparatus 1 and a notifying method and process 2 applied in the Initiative notification apparatus 1, wherein basic structure and functions of conventional notification apparatus is already known to those skilled in the art and description of which is therefore omitted in the following for the description as follows to be focused on details of related structure of the Initiative notification apparatus of the present invention and its notifying method. The present invention is primarily characterized in disclosing an Initiative notification apparatus 1 and design of notifying process 2. Moreover, what is to be clarified in advance is that, diagrams referred to in the following description are only to illustrate structure related to characteristics of the present invention and are not made according to actual scale.

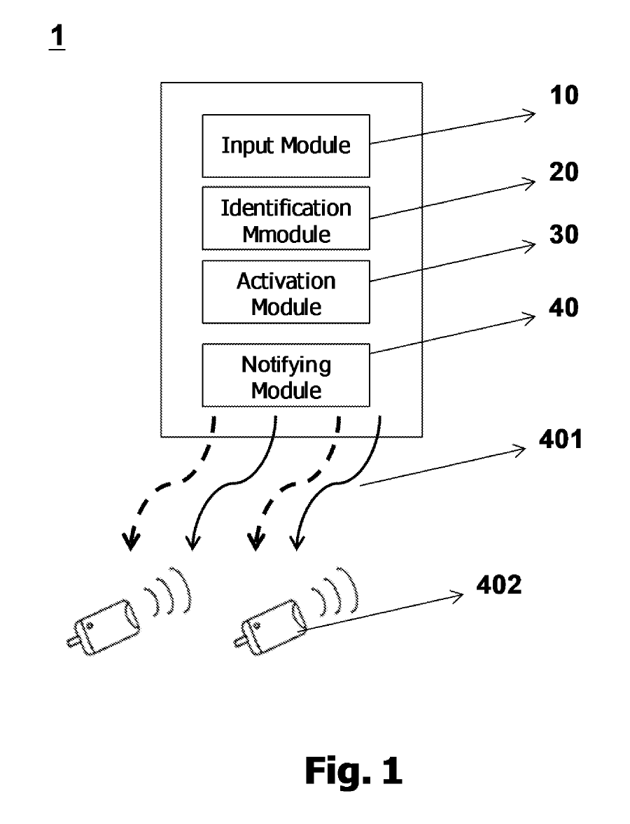

Referring to FIG. 1, which is a function block diagram of the Initiative notification apparatus of the present invention. The Initiative notification apparatus of the present invention comprises: an input module 10, provided for the user to enter a password 101, wherein the password 101 entered is a string of Arabic numerals, English letters, or any identifiable symbols; in the embodiment of the present invention, the input module 10 can be a numeric keypad or a touch panel with which numbers can be entered. An identification module 20, which is connected to the input module 10 and provided with a notifying process that is provided for identifying the password 101 entered and outputting at least a control signal according to the identification result; in the embodiment of the present invention, the identification module 20 can be a control chip, wherein the control chip is provided with a notifying process, in which at least two passwords are set up, one password being password for security mode 102 and the other being password for emergency mode 103, and therefore the control chip determines whether the password 101 entered by the user is the password for security mode 102 or the password for emergency mode 103; the control chip then outputs at least a control signal according to the result of determining and identifying the password entered. An activation module 30, which is connected to the identification module 20 and performs a task according to the control signal output by the control chip. For example, when the Initiative notification apparatus is disposed on an electronic locking device on the door, the activation module 30 can perform the task of unlocking or locking according to the control signal of the identification module 20; apparently, when the control chip determines that the password 101 entered is the password for security mode 102, it outputs a control signal for unlocking the lock to the activation module 30 for the task of unlocking the lock to be performed, and thus the door can open for the user to enter; or when the control chip determines that the password 101 entered is the password for emergency mode 103, it outputs a control signal for unlocking the lock to the activation module 30 for the task of unlocking the lock to be performed, and thus the door can open for the user to enter; or when the control chip determines that the password 101 entered is an incorrect one (neither the setup password for security mode 102 nor the setup password for emergency mode 103), it can select not to output any control signal so that the activation module 30 does not perform the task of unlocking the lock and thus the door cannot open. A notifying module 40, which is connected to the identification module 20 and performs a notifying process according to the identification result of the identification module 20; for example, when the control chip determines that the password 101 entered is the password for emergency mode 103, it outputs a control signal to the activation module 30 for a task (of unlocking the lock for example, for the door to open for the user to enter) to be performed and also outputs another control signal to the notifying module 40 for a notifying process to be performed; or when the control chip determines that the password 101 entered is an incorrect one, the activation module 30 does not output a signal for a task to be performed and a control signal is output to the notifying module 40 for a notifying process to be performed.

As described above, in the embodiment of the present invention, the notifying process is provided and saved in the identification module 20; for example, the notifying process is provided and saved in the control chip; when the control chip determines that the password 101 entered is the password for emergency mode 103, it outputs a control signal to the activation module 30 and outputs another control signal to the notifying module 40 for a setup notifying process to be performed; wherein, the notifying module 40 can be a subscriber identity model module (SIM module), a Global System for Mobile Communications module (GSM module), or other wired or wireless communications modules. For example, the notifying process provided in the memory unit of the SIM module or the GSM module (not shown in Figure) is performed to notify or send text massages to related persons; wherein, the notifying process will be described in the following. However, the notifying module 40 of the present invention is not limited to the SIM module; for example: when the notifying module 40 receives the control signal output by the identification module 20, the notifying module 40 activates a setup output signal 401, which can notify the setup recipient end 402 via wireless or wired transmission. Moreover, the notifying module 40 can also be set up in a control server of the security system already owned by the user; therefore, a control signal can be output via the already available security system to inform guard(s) or related persons that there is an emergency where the user is located and immediate rescue is needed.

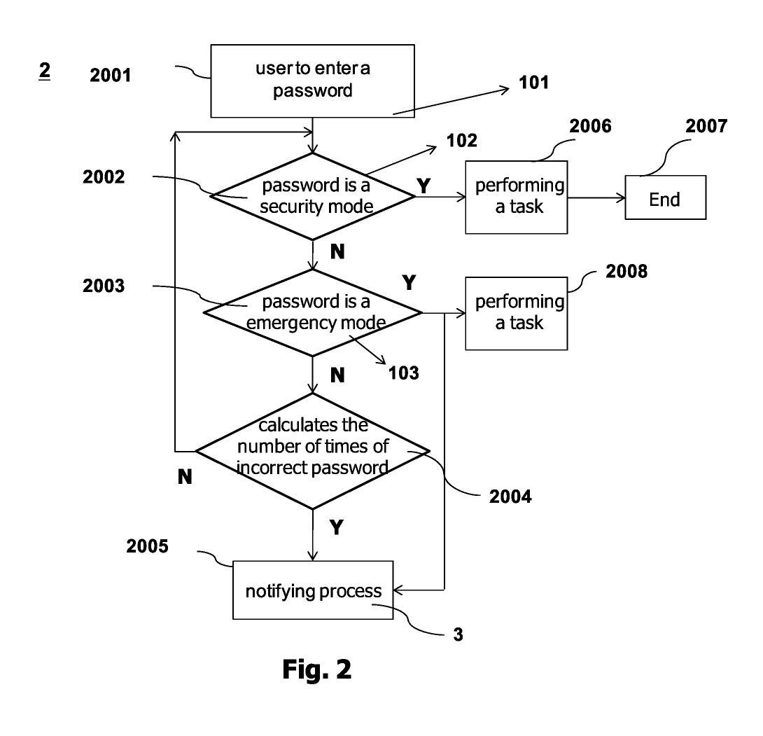

Then, referring to FIG. 2, in which is an embodiment of the notifying process of the Initiative notification apparatus of the present invention. As described above, in the Initiative notification apparatus of the present invention, the notifying process is provided in the identification module 20 of the Initiative notification apparatus for the identification module 20 to identify the password entered via the input module 10 and to output at least a control signal to the activation module 30 or a control signal to the activation module 30 and the notifying module 40 according to the identification result, detailed procedures of which are described in the following.

As shown in FIG. 2, the notifying method formed by the notifying process 2 of the present embodiment comprises: step 2001: the user enters via the input module 10 a password 101 consisting of a plurality of Arabic numerals, English letters, or any identifiable symbols; then follows step 2002, if the password 101 entered is the same as the setup password for security mode 102, the notifying process in the identification module 20 is provided to identify the password 101 entered as the password of the safety 102 and the identification module 20 outputs a control signal; and then follows step 2006, the control signal output by the identification module 20 is received by the activation module 30, and the activation module 30 outputs a signal for a task to be performed, i.e. the task of unlocking the electronic lock device; finally, the process ends, as shown in step 2007.

Moreover, as shown in FIG. 2, when the password 101 entered by the user in step 2001 is identified as the password for emergency mode 103, then follows step 2002, the notifying process provided in the identification module 20 identifies that the password for emergency mode 103 is entered and is different from the setup password for security mode 102; then follows step 2003; in step 2003, if the password 101 entered is the setup password for emergency mode 103, the notifying process provided in the identification module 20 is able to identify the password entered as the same as the setup password for emergency mode 103, and the identification module 20 will simultaneously or respectively output a first control signal and a second control signal; then follows step 2008; upon receiving the first control signal output by the identification module 20, the activation module 30 outputs a signal 2006 for performing a task, i.e. the task to unlock the electronic locking device; meantime, the second control signal output by the identification module 20 is also received by the notifying module 40 for a setup notifying process 3 to be performed, as shown in step 2005. As step 2005 informs related parties or persons according to the setup notifying process 3, the notified parties or persons are informed by the notifying process 3 that the user is currently in danger and have to immediately proceed to the location where the user is to carry out further action. Apparently, in the embodiment of the present invention, when the user is under a specific situation, being forced by culprit(s) to unlock the electronic locking device for example, the user enters the setup password for emergency mode 103 via the input module 10, and the identification module 20 identifies the password entered as the password for emergency mode 103 and thus outputs a first control signal for the activation module 30 to unlock the electronic locking device and also a second control signal to activate the notifying module 40 for a setup notifying process 3 to be performed for notifying related parties or persons for immediate rescue. Wherein, culprit(s) are not able to know the setup password for security mode 102 and the password for emergency mode 103, and no matter the user enters the password for security mode 102 or the password for emergency mode 103 via the input module 10, the Initiative notification apparatus of the present invention outputs a signal for a task to be performed (the task of unlocking the electronic locking device for example). Apparently, when the user enters the setup password for emergency mode 103, the culprit(s) are not aware that the Initiative notification apparatus of the present invention has been activated and performed the notifying process 3 and will not hurt the user; therefore, the Initiative notification apparatus of the present invention is able to protect personal and property safety of the user without arousing the suspicion of culprit(s).

And then, when a third person, i.e. a person other than the one who sets up the Initiative notification apparatus, enters an incorrect password via the input module 10 (neither the setup password for security mode 102 nor the setup password for emergency mode 103), since this third person does not know the setup password for security mode 102 or password for emergency mode 103 set up in the Initiative notification apparatus, then follows step 2001 after this third person enters an incorrect password via the input module 10; then follows step 2002, wherein the notifying process provided in the identification module 20 identifies the incorrect password entered as different from the setup password for security mode 102; then follows step 2003; in step 2003, if the incorrect password entered is also identified as different from the setup password for emergency mode 103, then follows step 2004; in step 2004, the identification module 20 calculates the number of times an incorrect password is entered and matches this number with a setup number of times, when the number of times an incorrect password is entered is different from the setup number of times, the Initiative notification apparatus remains at normal status (i.e. original status); if the third person enters different incorrect passwords via the input module 10 for multiple times, then when the number of times an incorrect password is entered reaches the setup number of times, 4 times for example, namely, an incorrect password being entered 4 times, the identification module 20 of the present embodiment controls the activation module 30 to remain at original status and simultaneously outputs a third control signal to the notifying module 40 for a notifying process to be performed, and thus the notifying module 40 performs the setup notifying process 3 as described above, as shown in step 2005. As step 2005 notifies related parties or persons according to the setup notifying process 3, the notified parties or persons are informed by the notifying process 3 that the user is currently in danger and have to immediately proceed to the location where the user is to carry out further action. Apparently, the notifying process 3 of the present embodiment of the Initiative notification apparatus of the present invention can be activated and performed without arousing the suspicion of culprit(s) and to protect personal and property safety of the user.

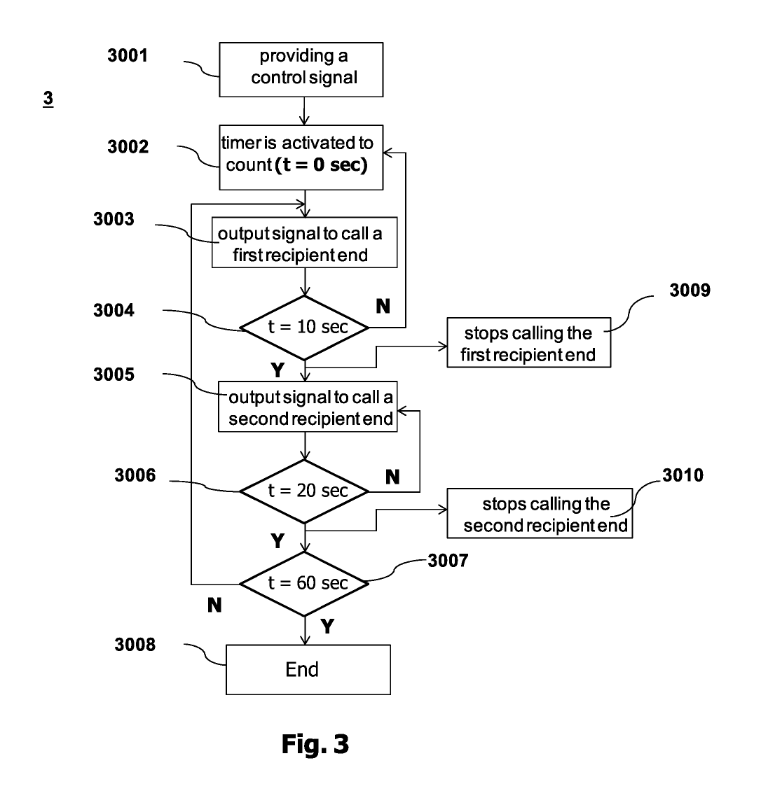

Referring then to FIG. 3, which is a diagram of the notifying process in the notifying method of the present invention. As shown in FIG. 3, the notifying process 3 of the present invention comprises: providing a control signal to activate the notifying process 3, wherein the control signal is a second control signal or a third control signal provided by the identification module 20 according to the notifying process and to the identification result of the password entered by the user with the setup passwords set up for the notifying process, as shown in step 3001. Then, after the control signal provided by the identification module 20 is received, a timer is activated to count (t=0 sec), as shown in step 3002. Then, an output signal 401 is output by the notifying module 40 to notify a first recipient end, as shown in step 3003; the output signal 401 here can be output via wired or wireless transmission to the first recipient end; for example, the notifying module 40 is connected to an emergency apparatus in the guardroom in the place where the user is located via a conducting wire, and when the emergency apparatus receives an output signal 401 output by the notifying module 40, the alarm ring is activated and the location of the user is indicated to inform guard(s) or related persons that there is an emergency where the user is located and immediate rescue is needed. For another example: the notifying module 40 is connected to a control server of security system already owned by the user, and therefore a warning signal can be emitted via the already available security system to inform guard(s) or related persons that there is an emergency where the user is located and immediate action needs to be taken. For still another example: the notifying module 40 can also be connected to an emergency apparatus in the guardroom in the place where the user is located via other routes (such as telephone or computer network connected by electric wires, cables, or fiber cables) or a wireless communications system (such as Bluetooth system or wireless network), and when the emergency apparatus receives an output signal 401 output by the notifying module 40, the alarm ring is activated and the location of the user is indicated to inform guard(s) that there is an emergency where the user is located and immediate rescue is needed. For yet another example, the notifying module 40 can be a SIM module or a GSM module or any other wired or wireless communications modules. According to the setup of the SIM module or the GSM module, a dialing task is automatically performed to notify the first recipient end (mobile phone for example); when the first recipient end receives the output signal 401 output by the notifying module 40, there will be buzzing and warning messages such as “the user has an emergency” to inform and urge the first recipient end to immediately proceed to where the user is for further action. In the present embodiment, the way in which the notifying module 40 outputs the output signal 401 is not limited, and the function achieved in the present invention is to inform the first recipient end; moreover, the way of indication on the first recipient end is not limited either, which can be achieved by using textual signal(s), voice signal(s), flash signal(s), color signal(s) or combination of any of the above or text message(s); furthermore, the first recipient end is not limited in the present invention and can be a police station, a fire station, or any individual or group set up to be able to receive the output signal 401. What is to be emphasized here is that, the notifying module 40 of the present invention is not limited to the embodiments disclosed and described above; any apparatus that transmits the second control signal or the third control signal provided by the identification module 20 to the recipient end is an embodiment of the notifying module 40 of the present invention.

Then follows step 3004: the first timer counts and determines whether a second setup time (10 seconds for example) is reached, namely, during the 10-second span, the notifying module 40 incessantly outputs the output signal 401 to the first recipient end; when the first timer counts till the 10th second since the output signal 401 is output, the notifying module 40 immediately stops notifying the first recipient end, as shown in step 3009; meantime, when the first timer counts and determines that 10 seconds is reached after the output of the output signal 401, the notifying module 40 continues to output the output signal 401 to a second recipient end, as shown in step 3005; what is to be emphasized here is that, the transmitting method for notifying the second recipient end, the indication method on the second recipient end, and the individual or group on the second recipient end are the same as those for notifying or on the first recipient end and the description of which is thus omitted here.

And then follows step 3006: the first timer counts and determines whether the second setup time (10 seconds for example) is reached, namely, during the 10-second span, the notifying module 40 incessantly outputs the output signal 401 to the second recipient end; when the second timer counts and determines that 10 seconds is reached after the output of the output signal 401, the notifying module 40 immediately stops notifying the second recipient end, as shown in step 3010. Apparently, the number of recipient end in the present invention can be two or more than two.

Then follows step 3007: the second timer counts and determines whether the third setup time (60 seconds for example) is reached, wherein when the timer determines that 60 seconds is not yet reached, the notifying process goes back to step 3003 and re-starts incessantly outputting output signal 401 to the first recipient end till the first timer counts and determines that 10 seconds is reached after the output of the output signal 401 to the first recipient end, as shown in step 3004; the notifying module 40 immediately stops notifying the first recipient end, as shown in step 3009; meantime, when the first timer determines that 30 seconds is reached after the output of the output signal 401, step 3005 of the notifying process is repeated for the output signal 401 to be output to the second recipient end; when the notifying module 40 incessantly outputs the output signal 401 to the second recipient end, and the first timer determines that the 40th second is reached after the output of the output signal 401, the notifying module 40 immediately stops notifying the second recipient end, as shown in step 3010. And when the second timer determines that 60 seconds is not yet reached, as shown in step 3007, the notifying process performs again the aforementioned procedure till the second timer determines that 60 seconds is reached, and then the notifying process 3 is stopped, as shown in step 3008. What is to be further clarified is that, the first timer and the second timer are here differentiated only to facilitate the description; in a preferred embodiment, the Initiative notification apparatus or the control chip of the present invention is disposed with only one timer, and time can be counted and determined by the control chip.

Apparently, one of the major technical characteristics of the present invention is that, with the Initiative notification apparatus and the notifying method of the present invention, the apparatus is able to automatically inform the recipient end when the user is threatened or forced by culprit(s) without arousing the suspicion of culprit(s); and in order to ensure that the recipient end can be effectively and successfully informed, the notifying process 3 in the notifying method provided by the present invention informs a plurality of recipient ends and each recipient end is not just informed more than once but also incessantly notified, whereby protection of personal and property safety of the user is further secured and enhanced.

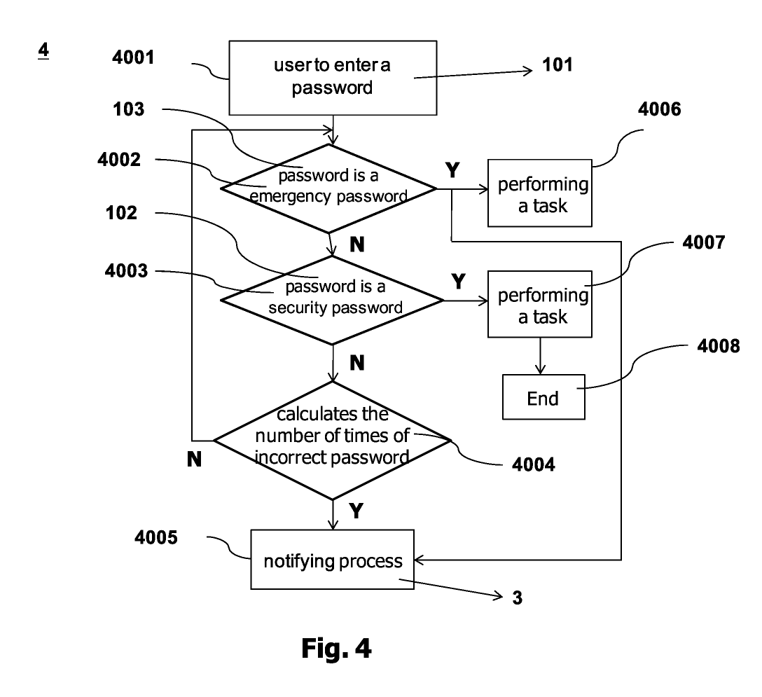

Referring then to FIG. 4, which is a diagram of another embodiment of the notifying process of the Initiative notification apparatus of the present invention. First, as described above, the notifying process of the invention is provided in the identification module 20 of the Initiative notification apparatus, so that the identification module 20 can identify the password entered via the input module 10 and output at least a control signal to the activation module 30 and/or the notifying module 40 according to the identification result of the password entered, detailed process of which is described as follows.

Then, referring to FIG. 4, in which is the notifying method formed by the notifying process 2 of the present embodiment, which comprises: step 4001, wherein the user enters via the input module 10 a password 101 consisting of a plurality of Arabic numerals, English letters, or any identifiable symbols; then follows step 4002, wherein the notifying process provided in the identification module 20 identifies whether the password 101 entered is the same as the password for emergency mode 103; when the password 101 entered is the same as the password for emergency mode 103, the identification module 20 simultaneously or respectively outputs a first control signal and a second control signal; then follows step 4006, upon receiving the first control signal output by the identification module 20, the activation module 30 immediately outputs a signal for performing a task (the task to unlock the electronic locking device for example); meantime, the notifying module 40 receives the second control signal output by the identification module 20 and performs a setup notifying process 3, as shown in step 4005. When the setup notifying process 3 shown in FIG. 3 notifies related parties or persons in step 4005, these related parties or persons are informed that the user is currently in danger and have to immediately proceed to the location where the user is for further action. Apparently, in the embodiment of the Initiative notification apparatus of the present invention being disposed in an electronic locking device, when the user is under a specific situation, being forced by culprit(s) to unlock the lock for example, the user enters via the input module 10 the setup password for emergency mode 103, which is thus identified by the identification module 20 as the setup password for emergency mode 103, the identification module 20 not only outputs a first control signal for the activation module 30 to unlock the electronic locking device, but also outputs a second control signal to activate the notifying module 40 for performing a setup notifying process 3 to inform the recipient end of the user's need for immediate rescue. Since culprit(s) know neither the password for security mode 102 nor the password for emergency mode 103 set up by the user, and no matter the password entered via the input module 10 is password for security mode 102 or password for emergency mode 103, the electronic locking device will still be unlocked by the signal of unlocking the lock output by the activation module 30, culprit(s) will not become suspicious and will not harm the user; therefore, the user is able to enter the setup password for emergency mode 103 and activate and perform the notifying process of the present invention without being discovered by culprit(s). Therefore, the Initiative notification apparatus of the present invention is able to protect personal safety of the user without arousing the suspicion of culprit(s).

If the password 101 entered by the user in step 4001 is the same as the password for security mode 102, step 4002 then follows, wherein the notifying process provided in the identification module 20 identifies that the password for security mode 102 entered is different from the setup password of emergency 103; then follows step 4003; in step 4003, if the password 101 entered is the same as the setup password for security mode 102, the identification module 20 outputs a control signal; then follows step 4007, wherein upon receiving a control signal from the identification module 20, the activation module 30 outputs a signal to perform a task (the task for unlocking the electronic locking device for example); finally, the process ends, as shown in step 4008.

And then, when a third person, i.e. a person other than the one who sets up the Initiative notification apparatus, enters an incorrect password via the input module 10 (neither the setup password for security mode 102 nor the setup password for emergency mode 103), since this third person does not know the setup password for security mode 102 or password for emergency mode 103 set up in the Initiative notification apparatus, then follows step 4001 after this third person enters an incorrect password via the input module 10; then follows step 4002, wherein the notifying process provided in the identification module 20 identifies the incorrect password entered as different from the setup password for emergency mode 103; then follows step 4003; in step 4003, if the incorrect password entered is also identified as different from the setup password for security mode 102, then follows step 4004; in step 4004, the identification module 20 calculates the number of times an incorrect password is entered and matches this number with a setup number of times, when the number of times an incorrect password is entered is different from the setup number of times, the Initiative notification apparatus remains at normal status (i.e. original status); if the third person enters different incorrect passwords via the input module 10 for multiple times, then when the number of times an incorrect password is entered reaches the setup number of times, 4 times for example, namely, an incorrect password being entered 4 times, the identification module 20 of the present embodiment controls the activation module 30 to remain at original status and simultaneously outputs a third control signal to the notifying module 40 for a notifying process to be performed, and thus the notifying module 40 performs the setup notifying process 3 as described above, as shown in step 4005. As step 4005 notifies related parties or persons according to the setup notifying process 3, the notified parties or persons are informed by the notifying process 3 that the user is currently in danger and have to immediately proceed to the location where the user is to carry out further action. Apparently, the embodiment of electronic locking device according to the present invention can prevent burglaries; with the notifying process 3 of the present embodiment, the electronic locking device will be activated and the notifying process 3 will be performed without arousing the suspicion of culprit(s) and to protect dwelling and property safety of the user. In addition, what is to be emphasized is that, in the present embodiment, the notifying process 3 is the same as that shown in FIG. 3 and the description of which is thus omitted.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An Initiative notifying apparatus, comprising:
an input module, provided for the user to enter a password;
an identification module, connected to said input module, a notifying process being provided in said identification module and at least a password for security mode and a password for emergency mode being set up in said notifying process, said notifying process matching said password entered with said password for security mode and said password for emergency mode for identification and outputting at least a first control signal or a first control signal and a second control signal after completing identification;
a notifying module, connected to said identification module, a notifying process being provided in said notifying module, said notifying module performing said notifying process according to said second control signal output by said identification module; wherein,
when said identification module identifies said password entered as the same as said password for security mode, said identification module outputs said first control signal;
when said identification module identifies said password entered as the same as said password for emergency mode, said identification module outputs said first control signal and also said second control signal for said notifying process to be performed.

2. The Initiative notifying apparatus according to claim 1, further comprising an activation module, said activation module being connected to said identification module and performing a task according to said first control signal output by said identification module.

3. The Initiative notifying apparatus according to claim 1, wherein when said identification module identifies said password entered as different from said password for security mode and from said password for emergency mode, said identification module further outputs a third control signal, and said notifying module performs said notifying process receiving said third control signal.

4. The Initiative notifying apparatus according to claim 1, wherein said notifying process notifies at least one recipient end, and each said recipient end is notified at least once.

5. The Initiative notifying apparatus according to claim 2, wherein said notifying process notifies at least one recipient end, and each said recipient end is notified at least once.

6. The Initiative notifying apparatus according to claim 3, wherein said notifying process notifies at least one recipient end, and each said recipient end is notified at least once.

7. The Initiative notifying apparatus according to claim 1, wherein said notifying module is selected from the group consisting of: subscriber identity model module (SIM module), Global System for Mobile Communications module (GSM module), wired communications modules, and wireless communications modules.

8. The Initiative notifying apparatus according to claim 2, wherein said notifying module is selected from the group consisting of: subscriber identity model module (SIM module), Global System for Mobile Communications module (GSM module), wired communications modules, and wireless communications modules.

9. The Initiative notifying apparatus according to claim 3, wherein said notifying module is selected from the group consisting of: subscriber identity model module (SIM module), Global System for Mobile Communications module (GSM module), wired communications modules, and wireless communications modules.

10. A notifying method, a notifying process formed by said notifying method being provided in an Initiative notifying apparatus, said Initiative notifying apparatus comprising an input module, an identification module connected to said input module, and a notifying module connected to said identification module, wherein said notifying method of said Initiative notifying apparatus comprises:
entering a password, said password being entered by the user via said input module;
identifying said password entered, at least a password for security mode and a password for emergency mode being set up in said identification module, said identification module matching said password entered with said password for security mode and said password for emergency mode for identification and outputting at least a first control signal and/or a second control signal after completing identification; wherein,
when said identification module identifies said password entered as the same as said password for security mode, said identification module outputs said first control signal;
when said identification module identifies said password entered as the same as said password for emergency mode, said identification module outputs said first control signal and also said second control signal to said notifying module, said notifying module performing a notifying process upon receiving said second control signal.

11. The notifying method according to claim 10, wherein when said identification module identifies said password entered as different from said password for security mode and from said password for emergency mode, said identification module further outputs a third control signal, and said notifying module performs said notifying process upon receiving said third control signal.

12. The notifying method according to claim 10, wherein said notifying process comprises:
a. activating said notifying process, and a timer starting to count (t=0 sec);
b. notifying a first recipient end, said first recipient end being notified by output signal output by said notifying module;
c. determining whether said timer counts to a first setup time, notifying of said first recipient end continuing when said first setup time is not yet reached, and notifying of said first recipient end being stopped and said notifying module outputting output signal to notify a second recipient end when said first setup time is reached;
d. determining whether said timer counts to a second setup time, notifying of said second recipient end continuing when said second setup time is not yet reached, and notifying of said second recipient end being stopped when said second setup time is reached;
e. determining whether said timer counts to a third setup time, performing steps b—d continuously when said third setup time is not yet reached.

13. The notifying method according to claim 10, wherein said notifying module is selected from the group consisting of: subscriber identity model module (SIM module), Global System for Mobile Communications module (GSM module), wired communications modules, and wireless communications modules.

14. An Initiative notifying apparatus, comprising an input module, an identification module connected to said input module, and a notifying module connected to said identification module, wherein said Initiative notifying apparatus is characterized in that:
said notifying module performs a notifying process according to a control signal output by said identification module, and said notifying process notifies at least one recipient end and each said recipient end is notified at least once.

15. The Initiative notifying apparatus according to claim 14, furthering comprising an activation module, said activation module being connected to said identification.

16. The Initiative notifying apparatus according to claim 14, wherein said notifying module is selected from the group consisting of: subscriber identity model module (SIM module), Global System for Mobile Communications module (GSM module), wired communications modules, and wireless communications modules.

17. A notifying process provided in an Initiative notifying apparatus, said Initiative notifying apparatus comprising an input module, an identification module connected to said input module, and a notifying module connected to said identification module, wherein said notifying process of said Initiative notifying apparatus comprises:
a. activating said notifying process 3, and a timer starting to count (t=0 sec);
b. notifying a first recipient end, said first recipient end being notified by output signal output by said notifying module;
c. determining whether said timer counts to a first setup time, notifying of said first recipient end continuing when said first setup time is not yet reached, and notifying of said first recipient end being stopped and said notifying module outputting output signal to notify a second recipient end when said first setup time is reached;
d. determining whether said timer counts to a second setup time, notifying of said second recipient end continuing when said second setup time is not yet reached, and notifying of said second recipient end being stopped when said second setup time is reached;
e. determining whether said timer counts to a third setup time, performing steps b—d continuously when said third setup time is not yet reached.

18. The notifying process according to claim 17, wherein said notifying module is selected from the group consisting of: subscriber identity model module (SIM module), Global System for Mobile Communications module (GSM module), wired communications modules, and wireless communications modules.
